(19) United States
(12) Patent Application Publication
(10) Pub. No.: US 2002/0118460 A1
(43) Pub. Date: Aug. 29, 2002

(54) One-way imaging optical window film

(75) Inventors: Lawrence Donald Woolf, Carlsbad, CA (US); Kirk Patrick Norton, San Diego, CA (US)

Correspondence Address: Thomas R. Juettner, Greer, Burns & Crain, Ltd., SUITE 2500, 300 SOUTH WACKER DRIVE, CHICAGO, IL, 60606, US

(73) Assignee: General Atomics

(21) Appl. No.: 09/793,330

(22) Filed: Feb. 26, 2001

(51) Int. Cl. G02B 27/00; G02B 1/10

(52) U.S. Cl. 359/585; 359/577

(57) ABSTRACT

A one-way imaging optical film is provided by a transparent polymer substrate bearing a first coating defining an image area and a second coating defining a background or surround area. In the visible light spectrum, the two coatings have very similar light transmittance characteristics and very similar reverse reflectance characteristics, but different reflectance characteristics such that when the film is viewed from the coated side the image area is visually distinct from the surround area, and when the film is viewed from the substrate side, the film is transparent and the image virtually non-discernible. The film has a visible light transmittance of at least about 25 percent for use especially as an architectural and vehicle window film.

### FIELD OF THE INVENTION

The invention relates to optical film or glass bearing one or more coatings defining an image area and a background or surround area such that when viewed from the coated side the image area is visually distinct from the surround area and when viewed from the glass or film side the glass or film is transparent and the image virtually non-discernible, i.e., invisible.

### BACKGROUND OF THE INVENTION

Signs, logos and images applied to windows and other transparent objects are customarily visible from both the inside and the outside of the window, with the image from the inside appearing in reverse or backward. In many cases, it would be desirable to have the image visible from only the outside of the window and to have a clear, transparent, unobstructed view from the inside of the window, i.e., with the image non-discernible from the inside of the window.

U.S. Pat. No. 5,731,898 to Orzi, et al., discloses optical glass having the above-described characteristics. Orzi achieves these results by providing an optical filter arrangement comprised of at least two optical filter elements, namely, the glass substrate and an optical coating on the substrate. The coating typically comprises at least two overlying optical thin films, e.g., chromium and silicon oxide.

In order to achieve a one-way discernible image on a transparent substrate, it is necessary to provide image and surround areas that have, in the visible spectrum, a distinct difference in visible light reflectance (VLR) and a very close match in visible light transmittance (VLT) and reverse reflectance (VLRR), i.e., reflectance from the glass or substrate side of the optical device. If there is a transmittance mismatch or a reverse reflectance mismatch, the image will be visible from both sides of the device.

In the Orzi designs, colored filter glass is used for the substrate in order to eliminate spectral regions where the transmission mismatch is greatest, and also to reduce a significant reverse reflectance mismatch. The use of colored filter glass in combination with optical filter coatings results in a very low overall VLT, typically about 10 percent, which is acceptable for sunglasses, but too low for architectural and vehicle window applications.

Using the Orzi designs, in conjunction with tabulated optical constants of the materials used by Orzi, results in optical transmittance values of about 10%, with close matches between image and surround in the regions between 500 and 700 nm, with significant deviations below 500 nm. The reverse reflection of the two areas differs significantly over the entire visible spectrum. Therefore, the Orzi designs do not provide guidance as to how to design higher transmittance designs.

An optical design is needed which has a very close transmission match, a very close reverse reflection match and a distinctive reflective color difference, and which is significantly more transmissive than the devices disclosed in the Orzi patent. It is also desirable to provide a design that minimizes the thickness of the coating materials employed so that one-way imaging products can be cost-effectively fabricated using sputtering techniques.

It is the object of the present invention to provide optical designs that satisfy and fulfill these needs.

### SUMMARY OF THE INVENTION

In accordance with the invention, a polymer substrate, such as polyethyleneterphthalate (PET), is coated with alternating layers of a metal and an oxide dielectric, preferably chromium and indium tin oxide (ITO), to provide an image area comprised of the substrate, a first relatively thin layer of metal, a relatively thick layer (first layer) of dielectric and a second relatively thin layer of metal, and a surround area comprised of the same construct as the image area plus a second relatively thick layer of dielectric and a third relatively thin layer of metal. The structure and the symmetry of design produce image and surround areas having, in the visible spectrum, a very close transmittance match, a very close reverse reflectance match, and a distinctive difference in reflectance and color. Also, the design provides significantly increased visible light transmission, specifically about 25 to 50 percent, as required for architectural and vehicle windows.

The thickness of the respective layers of metal and dielectric may be varied to achieve different objectives. For example, the thickness of the second metal layer may be varied to control transmittance; the thickness of the second oxide layer may be varied to change the color and/or intensity of the background or surround area to enhance or control the one-way visibility of the image area; and the thickness of the third metal layer may be varied to facilitate attachment of the coated side of the one-way optical film to glass or to a protective polymer film without diminution of the one-way optical characteristics. The attachment of the coated side of the one-way optical film to a protective polymer film has been found to lead to an optimum transmission and reverse reflection match even better than is obtainable without the protective polymer film. The third metal layer must be varied somewhat to provide this optimum transmission and reverse reflection match.

The construction and the many advantages of the optical films of the invention will become apparent to those of reasonable skill in the art from the following detailed description, as considered in conjunction with the accompanying drawings.

### BRIEF DESCRIPTION OF THE DRAWINGS

FIG. 1 is a fragmentary cross-sectional view, on a greatly magnified scale, of one embodiment of the one-way imaging film of the invention;

FIG. 2 is a fragmentary cross-sectional view, on a greatly magnified scale, of a second embodiment of the one-way imaging film of the invention;

FIG. 3 is a graph illustrating the visible light transmittance characteristics of the image and surround areas of the one-way imaging film of the invention;

FIG. 4 is a graph illustrating the reverse reflectance characteristics of the image and surround areas of the one-way imaging film of the invention;

FIG. 5 is a graph illustrating the absorptance characteristics of the image and surround areas of the one-way imaging film of the invention when light is incident on the substrate side of the film; and

FIGS. 6 and 7 are graphs illustrating the visible light reflectance characteristics of the image area in comparison with the visible light reflectance and color characteristics of a number of surround areas formed by the use of various thicknesses of indium tin oxide in the second oxide layer.

### DETAILED DESCRIPTION OF PREFERRED EMBODIMENTS

The following is a detailed description of certain embodiments of the invention presently deemed by the inventors to be the best mode of carrying out the invention.

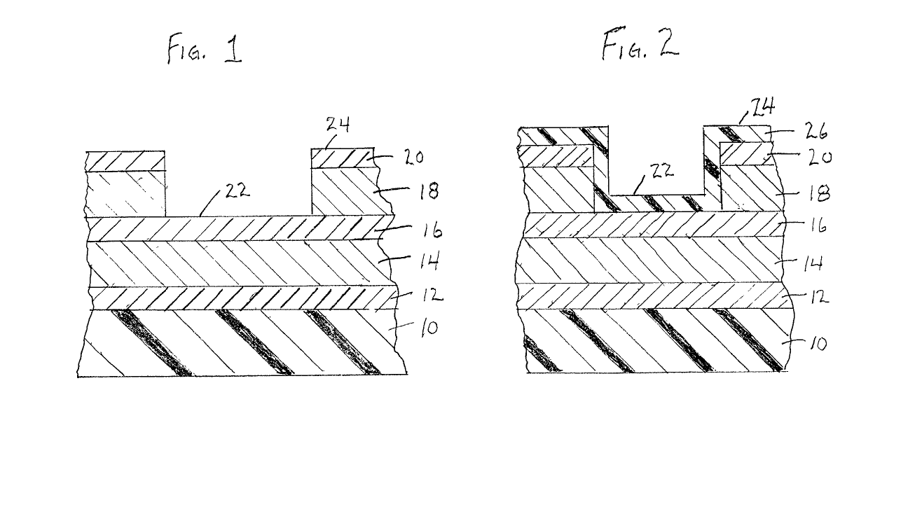

Referring to FIG. 1, a first embodiment of the one-way imaging film of the invention is illustrated as being comprised of a transparent substrate 10, a first layer 12 of metal deposited on the substrate, a first layer 14 of dielectric deposited on the metal layer 12, a second layer 16 of metal deposited on the dielectric layer 14, an interrupted second layer 18 of dielectric on the metal layer 16, and an interrupted third layer 20 of metal deposited on and in conformance with the interrupted layer 18.

The interruptions in the layers 18 and 20 expose the surface of the layer 16 and define one or more image areas 22 comprised of the substrate 10 and the metal-dielectric-metal layers 12, 14 and 16. The retained portions or parts of the layers 18 and 20 define a background or surrounding (“surround”) area comprised of the substrate 10 and the metal-dielectric-metal-dielectric-metal layers 12, 14, 16, 18 and 20.

The substrate may be plastic or glass and is preferably a transparent polymer film of the type conventionally employed for solar control window films, such as polyethyleneterphthalate (PET), at conventionally employed thicknesses, e.g., 1-2 and up to 50 mils.

The metal or metals used for the layers 12, 16 and 20 may be any of the metals conventionally used for solar control films, such as silver, gold, aluminum, copper, stainless steel, chromium and chromium alloys. The layers need not all be of the same metal. However, for optimum practice of the present invention, chromium is the preferred metal for all of the metal layers.

Likewise, the material of the dielectric layers 14 and 18 may be selected from a variety of dielectric oxides conventionally used for solar control window films, so long as the refractive index is different from that of the metal, e.g., a dielectric material having an index of refraction in the order of 1.5 to 2.5. In addition, the dielectric should be substantially optically non-absorbing in the thicknesses used, namely 10-300 nm. The dielectric preferred for optimum practice of the present invention is indium tin oxide (ITO), although other dielectric materials with the same optical thickness may be used to obtain the same optical properties, as is known to those versed in the art.

The one-way imaging film is preferably produced in a web coater capable of processing wide, continuous webs of polymer substrate material, and including a plurality of deposition stations, preferably sputter deposition stations, for sputter depositing the metal and the dielectric oxide layers onto the substrate.

In the coater, the web is exposed to a first coating operation where the metal layer 12 is deposited onto the substrate 10, a second coating operation where the dielectric layer 14 is deposited on the layer 12, and third coating operation where the metal layer 16 is deposited on the layer 14.

After the first three layers have been deposited on the substrate, a mask having the same size, shape and configuration as the image desired to be produced is laid over a part or portion of the surface area of the metal layer 16. The mask may be a mechanical or strippable mask, a soluble paint or ink mask, a mask applied by silkscreen techniques or any other masking technique known in the art.

After the mask has been applied, the dielectric layer 18 and metal layer 20 are deposited in sequence onto the previously coated and masked substrate, i.e., onto the mask and the surface areas of the metal layer 16 not covered by the mask. The mask is then removed to define the image area or areas 22. The layers of dielectric and metal deposited over the mask are sufficiently porous that, for example, a mask produced with a soluble paint or ink is quite readily removed by exposure to a suitable solvent. In any event, as the mask is removed, the parts of the layers of dielectric and metal that were deposited over the mask are also removed, thereby to define a desired image area 22 within the field of a desired background or surround area 24.

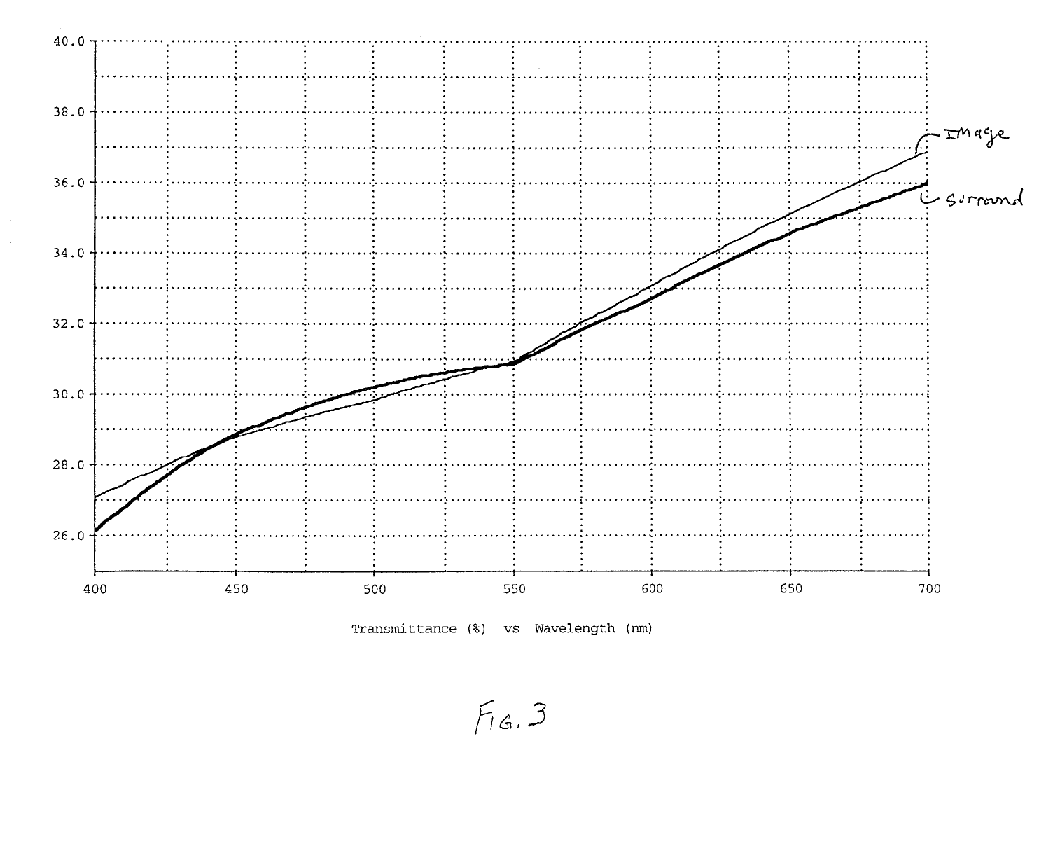

Referring to FIG. 2, a second and preferred embodiment of the invention is constructed of the same materials and in the same manner as the embodiment of FIG. 1 and additionally includes a transparent superstrate 26. The superstrate may be any suitable transparent material such as glass, clear plastic, hard coat or the like. Alternatively, if the one-way film is intended to be secured to the interior surface of a window, the superstrate 26 may suitably include a layer of adhesive. The superstrate 26 affords protection for the metal coatings of the image and surround areas 22 and 24. More significantly, the superstrate 26 allows for an improved visible light transmittance match and reverse reflectance match between the image and surround areas when the film is viewed from the substrate side compared to comparable designs without a superstrate.

In an optimum design of the one-way imaging film of the invention, the metal layer 12 is chromium at a thickness of 0.7 nanometers (nm), the dielectric oxide layer 14 is ITO at a thickness of 60 nm, the metal layer 16 is chromium at a thickness of 2.8 nm, the layer 18 is ITO at a thickness of 60 nm, the metal layer 20 is chromium at a thickness of 0.35 nm and the superstrate 26 is a 1 to 2 mil. thick film of clear plastic.

In judging the performance within the visible light spectrum of one-way imaging films, it is appropriate to consider the characteristics of the films over substantially the entire range of visible light energy, i.e., from about 400 to about 700 nm, and to give particular attention to the film's behavior within a narrower spectral range in the general vicinity of 550 nm where the human eye tends to have its maximum sensitivity.

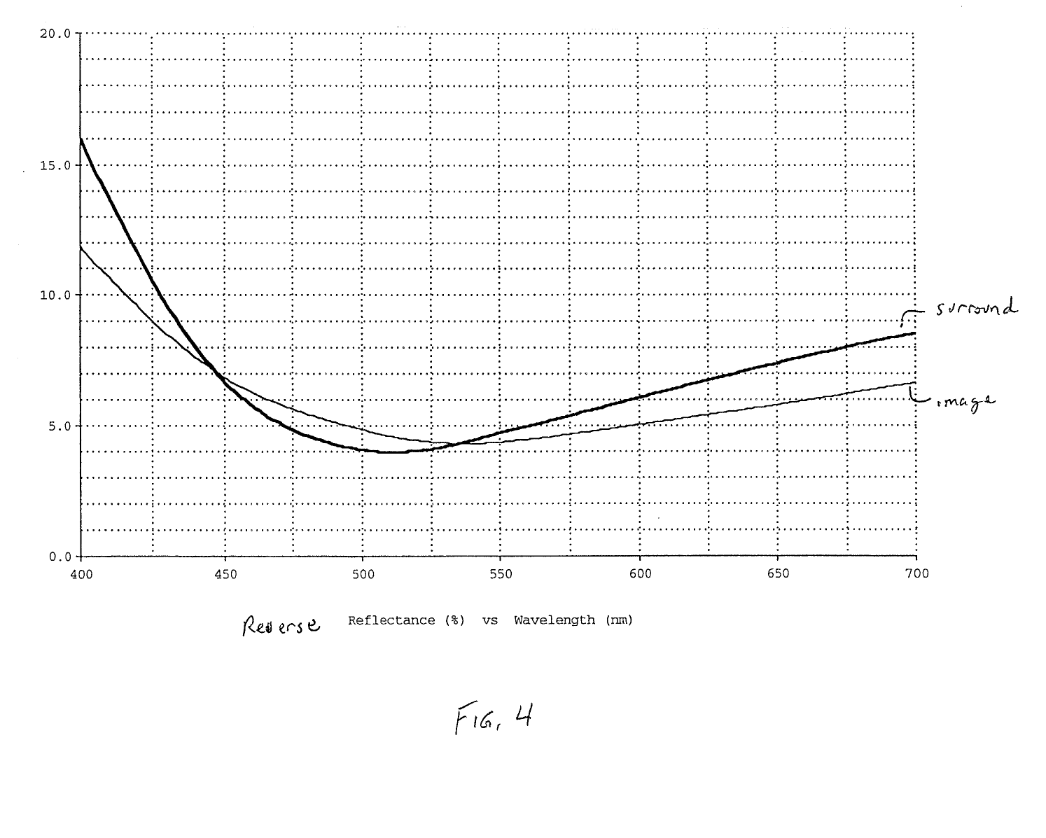

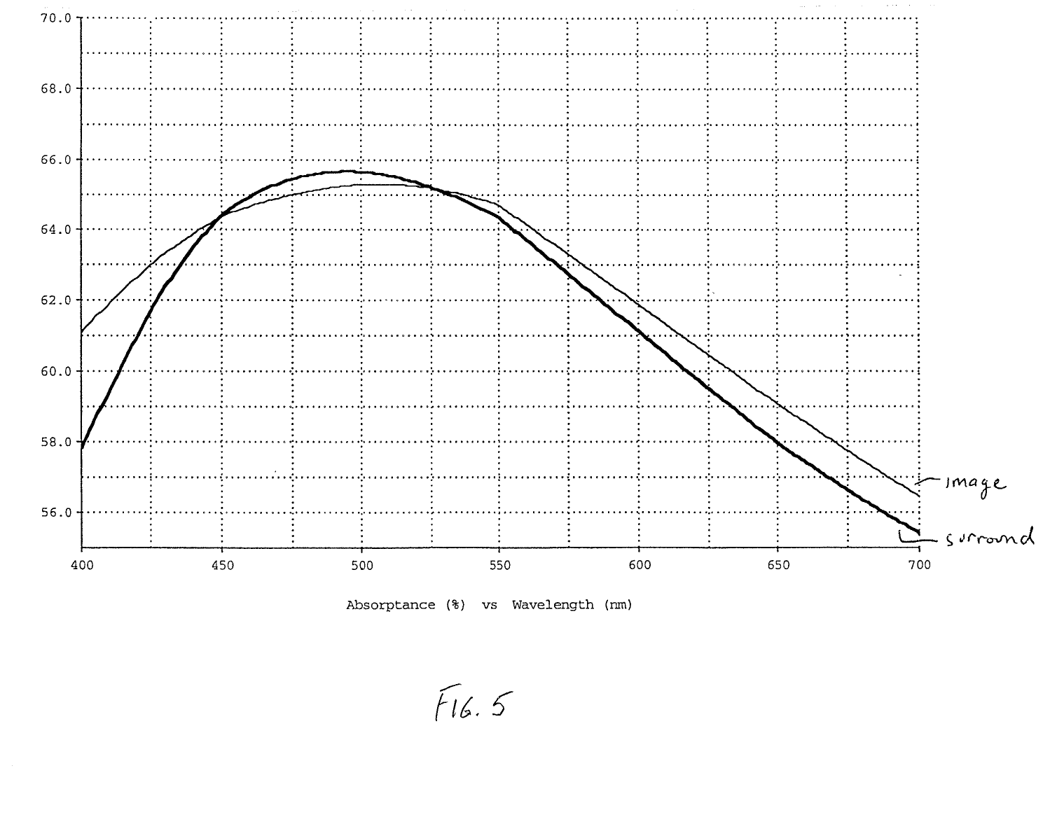

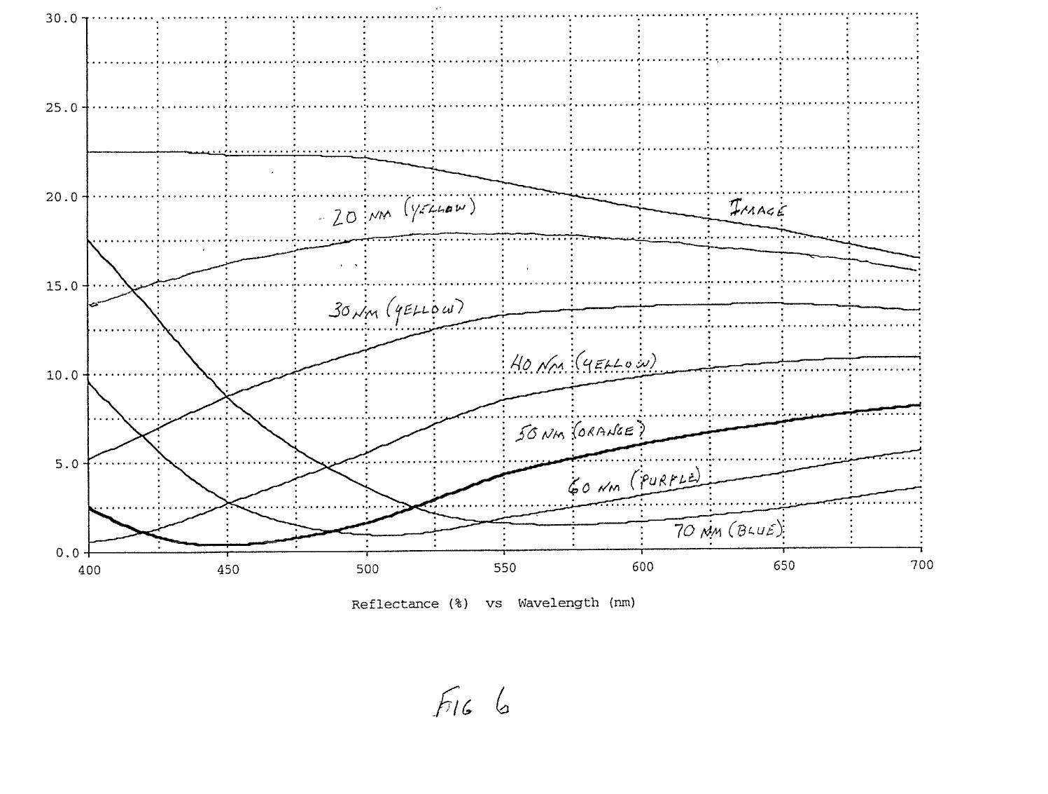

Referring to FIGS. 3, 4 and 5, it will be observed that a film fabricated at the above-described optimum design has a very close match between the image and surround areas in each of transmittance, reverse reflectance and absorptance. The VLT match is very nearly perfect and transmittance at 550 nm is 31 percent for both areas. Thirty-one percent transmittance is nearly ideal for vehicle and architectural windows.

If it is desired to increase transmittance to values of 35 percent and above, the thickness of the second chromium layer 16 may be reduced to about 2.2 nm or even 1.1 nm or less. A suitable thickness range for the second chromium layer is about 1-3 nm.

As previously mentioned, the third chromium layer must be varied somewhat to provide the optimum transmission and reverse reflection match. When using a polymer superstrate, the following designs provide for optimum transmission and reverse reflection match.

1. For a transmittance at 550 nm of about 36%, the following design is optimum:

First layer of 0.7 nm Cr

Second layer of 60 nm ITO

Third layer of 2.2 nm Cr

Fourth layer of 60 nm ITO

Fifth layer of 0.3 nm Cr

2. For a transmittance at 550 nm of about 40%, the following design is optimum:

First layer of 0.7 nm Cr

Second layer of 60 nm ITO

Third layer of 1.85 nm Cr

Fourth layer of 60 nm ITO

Fifth layer of 0.27 nm Cr

3. For a transmittance at 550 nm of about 50%, the following design is optimum:

First layer of 0.7 nm Cr

Second layer of 60 nm ITO

Third layer of 1.1 nm Cr

Fourth layer of 60 nm ITO

Fifth layer of 0.18 nm Cr

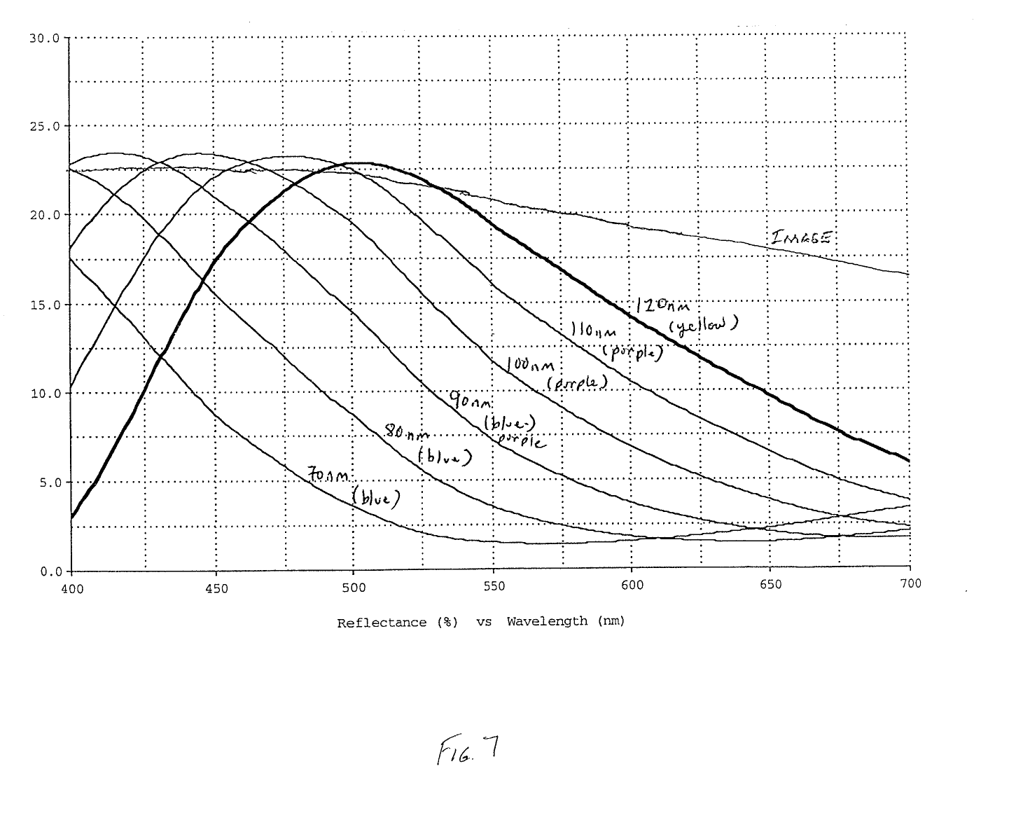

FIGS. 6 and 7 illustrate the reflectance of the image area 22 and the surround area 24 of the optimum design, and the color at 10 nm increments from 20 nm to 120 nm of various thicknesses of ITO in the second dielectric layer 18. As indicated by the FIG. 6 graph, a thickness of 60 nm of ITO in the layer 18 produces a maximum differential between the reflectance values of the two areas and also a maximum color contrast between the two areas. However, the thickness of the ITO layer 18 can be varied between about 20 and about 120 nm, preferably 30-110 nm, and more preferably 40-90 nm, to achieve a variety of colors while maintaining close transmission and reverse reflection match. The differential between the reflectance of the two areas should be at least 5 percent, and more preferably at least about 10 percent.

If the superstrate 26 or an equivalent thereof is not employed in the design, the thickness of the top layer 20 of chromium should preferably be increased to about 0.7 nm or more. A suitable range is about 0.25-1.0 nm.

Preferred embodiments of the invention are thus comprised of a conventional transparent polymer substrate 10, a layer 12 of chromium having a thickness in the order of about 0.7 nm, a layer 14 of ITO having a thickness in the order of about 60 nm, a layer 16 of chromium having a thickness in the order of about 1-3 nm, a layer 18 of ITO having a thickness in the order of about 20-120 nm, preferably 30-110 nm, and a layer 20 of chromium having a thickness in the order of about 0.18-1.0 nm. A one to two-mil thick superstrate 26 or equivalent is optional, but highly recommended.

The resultant films when applied to windows provide excellent image reflection and contrast when viewed from the exterior and a clear, unobstructed view at high transmittance when viewed from the interior. The transmission match and reverse reflection match are closer than in prior designs. Transmission values are higher and reverse reflection values lower. The image has higher front surface reflective brightness and there is more contrast between image and surround. The films provide one-way imaging technology for use on windows where no image is visible from inside the window, there is substantial transmittance through the window, and the reflected image on the outside of the window is distinct with high contrast and image brightness.

The objects and advantages of the invention have thus been shown to be attained in a convenient, economical, facile and practical manner.

While certain embodiments of the invention have been herein illustrated and described, it is to be appreciated that various changes, rearrangements and modifications may be made therein without departing from the scope of the invention as defined by the appended claims.

What is claimed is:

1. A one-way imaging optical film comprising a transparent substrate having coatings thereon defining an image area and a surround area,
the coating defining the image area comprising a first layer of metal deposited on the substrate, a first layer of a dielectric deposited on said first layer of metal, and a second layer of metal deposited on said first layer of dielectric,
the coating defining the surround area comprising the same construct as the coating defining the image area and a second layer of a dielectric deposited on said second layer of metal and a third layer of metal deposited on said second layer of dielectric,
the coatings, in the visible light spectrum, having similar values of light transmittance and similar values of reverse reflectance when the film is viewed from the substrate side thereof and different values of reflectance when the film is viewed from the coated side thereof,
the image area being visually distinct from the surround area when the film is viewed from the coated side thereof and being virtually non-discernible when the film is viewed from the substrate side thereof.

2. A film as set forth in claim 1 wherein the visible light transmittance of both of said areas at 550 nm is at least about 25 percent.

3. A film as set forth in claim 1 wherein the difference between the reflectance values of the two coatings at 550 nm is at least about 5 percent.

4. A film as set forth in claim 1 wherein said first layer of metal has a thickness in the order of about 0.7 nm, said first layer of dielectric has a thickness in the order of about 60 nm, said second layer of metal has a thickness in the order of about 1 to 3 nm, said second layer of dielectric has a thickness in the order of 30 to 110 nm, and said third layer of metal has a thickness in the order of about 0.18 to 1.0 nm.

5. A film as set forth in claim 1 wherein the metal layers are chromium and the dielectric layers are indium tin oxide.

6. A film as set forth in claim 1 wherein said first layer of metal is a layer of chromium having a thickness in the order of about 0.7 nm, said first layer of dielectric is a layer of indium tin oxide having a thickness in the order of about 60 nm, said second layer of metal is a layer of chromium having a thickness in the order of about 1 to 3 nm, said second layer of dielectric is a layer of indium tin oxide having a thickness in the order of 30 to 110 nm, and said third layer of metal is a layer of chromium having a thickness in the order of about 0.18 to 1.0 nm.

7. A film as set forth in claim 6 wherein said second layer of dielectric has a thickness in the order of about 40-90 nm.

8. A film as set forth in claim 6 wherein said third layer of metal is exposed and has a thickness in the order of about 0.7 nm.

9. A film as set forth in claim 6 wherein said third layer of metal is affixed to glass or a polymer film and has a thickness in the order of about 0.18 to 0.35 nm.

10. A film as set forth in claim 1 further comprising a transparent film overlying said coatings.

11. A film as set forth in claim 1 wherein said substrate comprises a polymer film.

12. A one-way imaging optical film comprising a transparent polymer substrate having coatings thereon defining an image area and a surround area,
the coating defining the image area comprising a first layer of chromium deposited on the substrate and having a thickness in the order of about 0.7 nm, a layer of indium tin oxide deposited on said first layer of chromium and having a thickness in the order of about 60 nm, and a second layer of chromium deposited on said layer of indium tin oxide and having a thickness in the order of about 1 to 3 nm,
the coating defining the surround area comprising the same three layers as the coating defining the image area and a second layer of indium tin oxide deposited on said second layer of chromium and having a thickness in the order of about 30-110 nm, and a third layer of chromium deposited on said second layer of indium tin oxide and having a thickness in the order of about 0.18 to 1.0 nm,
the coatings, in the visible light spectrum, having similar values of light transmittance and similar values of reverse reflectance when the film is viewed from the substrate side thereof and different values of reflectance when viewed from the coated side thereof,
the image area being visually distinct from the surround area when the film is viewed from the coated side thereof and being virtually non-discernible when the film is viewed from the substrate side thereof,
said coatings at 550 nm having a visible light transmittance of at least about 25 percent and a reflectance value differential of at least about 5 percent.

13. A film as set forth in claim 12 further comprising a transparent film having a thickness in the order of about 1-2 mils overlying said coatings.

14. A process of making one-way imaging optical film comprising the steps of
providing a transparent substrate,
depositing a first layer of metal onto the substrate,
depositing a first layer of dielectric onto the first layer of metal,
depositing a second layer of metal onto the first layer of dielectric,
applying a mask of an image onto part of the surface area of said second layer of metal,
depositing a second layer of dielectric onto the mask and the surface area of the second layer of metal not covered by the mask,
depositing a third layer of metal onto the second layer of dielectric, and
removing the mask to define an image area comprised of the substrate, the first layer of metal, the first layer of dielectric and the second layer of metal, and a surround area comprised of the substrate, the first layer of metal, the first layer of dielectric, the second layer of metal, the second layer of dielectric, and the third layer of metal,
the layers of metal and dielectric being selected and being deposited at respective thicknesses, such that the image area and the surround area have in the visible light spectrum similar values of light transmittance and similar values of reverse reflectance when the film is viewed from the substrate side thereof, and different values of reflectance when the film is viewed from the coated side thereof,
the image area being visually distinct from the surround area when the film is viewed from the coated side thereof and being virtually non-discernible when the film is viewed from the substrate side thereof,
the layers of metal and dielectric further being selected and being deposited at respective thicknesses, such that the image area and the surround area have, at 550 nm, a visible light transmittance of at least about 5 percent.

15. A process as set forth in claim 14 wherein the first layer of metal is deposited to a thickness of about 0.7 nm, the first layer of dielectric is deposited to a thickness of about 60 nm, the second layer of metal is deposited to a thickness of from about 1 to about 3 nm, the second layer of dielectric is deposited to a thickness of about 30 to 110 nm, and the third layer of metal is deposited to a thickness of about 0.18 to 1.0 nm.

16. A process as set forth in claim 14 wherein the layers of metal are chromium and the layers of dielectric are indium tin oxide.

17. A process as set forth in claim 16 wherein the first layer of chromium is deposited to a thickness of about 0.7 nm, the first layer of indium tin oxide is deposited to a thickness of about 60 nm, the second layer of chromium is deposited to a thickness of from about 1 to about 3 nm, the second layer of indium tin oxide is deposited to a thickness of about 30 to 110 nm, and the third layer of chromium is deposited to a thickness of about 0.18 to 1.0 nm.

18. A process as set forth in claim 17 wherein the second layer of chromium is deposited to a thickness of about 2.8 nm, the second layer of indium tin oxide is deposited to a thickness of about 60 nm, and the third layer of chromium is deposited to a thickness of about 0.35 nm.

19. A film as set forth in claim 17 wherein the second layer of chromium is deposited to a thickness of about 1.1-2.2 nm or less, the second layer of indium tin oxide is deposited to a thickness of about 40 to 70 nm, the third layer of chromium is deposited to a thickness of about 0.18 to 0.3 nm, and the image and surround area have a visible light transmittance at 550 nm of about 35 percent or more.

20. A process as set forth in claim 14 including the step of applying a polymer film over the image and surround area.
